(19) United States
(12) Patent Application Publication
(10) Pub. No.: US 2009/0158876 A1
(43) Pub. Date: Jun. 25, 2009

(54) MODULAR GEAR TEETH AND GEARS EMPLOYING SAME

(76) Inventors: Merle L. Sollars, Bloomington, IL (US); Donald L. Sollars, Milpitas, CA (US); Maureen E. Sollars, Bloomington, IL (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 11/963,025

(22) Filed: Dec. 21, 2007

(51) Int. Cl. F16H 55/00

(52) U.S. Cl. 74/462

(57) ABSTRACT

A group of networked elements for controlling the equipment of a building, when the elements are in a learning mode, can be assembled by a pair of actions. The first action exerted by an installer on one of the elements should be interpreted as an interrogation concerning the state of membership in the group (for example, as included or excluded) of one of the elements of the group. The first action triggers the emission of an information signal regarding the identified element's state. The following, or second, action exerted on the chosen element is interpretable as an order for modifying the state of membership in the group of the chosen element.

### FIELD OF THE INVENTION

The present invention relates generally to gearing, and more particularly to modular gear teeth and gears and gear systems employing modular gear teeth.

### BACKGROUND OF THE INVENTION

Gear making has evolved from hand carved wooden gears to modern machine cut gears made by hobbing, milling or shaping to form the final tooth contour. When a gear is manufactured, the basic raw part is generally termed a gear blank. The gear blank can be made of substantially any material from non-metallic and composite materials to iron and steel. The material selected depends upon the final application for the gear which in turn determines the manufacturing process selected. All gears have common elements. For example, a gear blank usually consists of a hub section, a web section, and a rim section on which the gear teeth are cut. The raw gear blank is then machined and contoured to a shape that best suits the type of final gear desired, and the teeth are then cut on the contoured rim. The blank can be contoured for a spur or helical gear, a worm gear, a bevel gear, or any other type of gear required. The hub section usually has an axial bore to receive a shaft upon which the gear will be mounted, and has a keyway to receive a driving shaft key. The web section can be solid or have spokes with spaces between the spokes to decrease the weight of the blank. The rim section is normally solid and material is removed as the teeth are cut. The gear blank can be cast, forged, welded together, or machined and contoured from a solid piece of material, or otherwise shaped in a known manner to fit the application.

Over time, gear design, engineering, machining, tooling, quality standards and finished tooth specifications, etc., have become standardized under standards set by standards organizations such as identified by acronyms, AGMA, JIGMA, and DIN. The standards cover substantially every aspect of gears including the type of gear blank, heat-treating and the quality class of tooth finish. For example, an AGMA class 5 gear is generally considered a standard conventional gear, while a class 13 gear is of higher quality and finish.

Because gear manufacturing techniques and tooth specifications have become relatively standardized, the gear making process has concentrated more on improvements in gear standards and less on changes in the manufacturing process or techniques. Machines for making gears have been improved but they still utilize known manufacturing techniques. With the increasing need for large gears, such as, spur gears having a diameter greater than approximately 15 feet, gear manufacturers have changed their manufacturing techniques from making complete unitary gears to making gears from gear segments. For example, by making a four-segment gear wherein each segment is a generally pie-shaped 90 degree segment, the segments can be cut, handled, and shipped to the point of use and then assembled into a single gear unit. While the segment system of manufacture has been adequate for some gears, it has limitations. Because each segment of the gear includes a segment of the hub, a segment of the web, and a segment of the rim on which the teeth are cut, the gear cannot be subjected to further finish as a whole, but only as segments. Each segment must undergo individual carburizing, hardening, and other processing. When the gear segments are finally assembled, differences may exist in the finish and quality of the individual segments due to differences in heat treating and cooling rates between segments. Frequently the size and weight of a segment may make uniform machining and processing difficult so that consistent higher class finishes may not be possible. Also, only a portion of a gear segment may need further processing so that processing the entire segment results in unnecessary processing of some portions with an associated increase in cost. Also, in the manufacture of gears made from expensive exotic materials, usually only the teeth need to be made from the exotic material. However, with known manufacturing techniques, the entire gear is generally made of the same material, with resultant higher manufacturing costs.

Another drawback with conventional gears is that the gear teeth are formed as an endless chain of teeth which are cut into either the periphery or the face of a gear blank so as to be integral with the gear blank. Each gear tooth is thus integrally connected to two adjacent teeth and cannot be removed and processed as an individual part. The failure or damage to one tooth effectively destroys the whole gear.

Accordingly, in view of the aforementioned shortcomings in the known gear manufacturing processes and techniques, a need exists for a gear design and gear manufacturing process that significantly reduces the cost of gear manufacture and results in economies not available with known gear technology.

### BRIEF SUMMARY OF THE INVENTION

One of the primary objects of the present invention is to provide modular gear teeth and gears employing such modular teeth that significantly reduce the cost of manufacture.

A more particular object of the present invention is to provide individual modular gear teeth that can be manufactured and processed independently of each other and mounted on a gear blank so as to form a spur gear, a helical gear, a worm gear, a bevel gear, or substantially any other type of gear.

Another object of the preset invention is to provide modular gear teeth that can be made as individual un-machined gear teeth by casting, forging, weldment, or machined from commercial stock. If made of metal, the heat treatment, gear class, type of finish, etc., can be readily obtained as prescribed by user specifications.

Another object of the present invention is to provide a gear blank that includes a hub, a web, and a rim, and has independent modular gear teeth mounted thereon of the same type, size and standard as required by user specifications. In one embodiment, the individual modular teeth are mounted on a substantially planar surface of a gear blank disposed normal to the axis of rotation of the gear so that the teeth oscillate about axes that are normal to the planar mounting surface and lie on a circle concentric with the axis of rotation of the gear, thereby facilitating use in a worm driven gear assembly.

In carrying out the present invention, a gear blank is provided that is preferably unitary and includes a hub, a web and a rim. Individual modular gear teeth are formed with each modular tooth including an elongated tooth body having a base surface, planar sidewalls and a recess extending the longitudinal length of the tooth body and defined between laterally spaced internal wall surfaces that extend from an inner bottom surface of the recess to an opening opposite the bottom surface. The recess has a predetermined transverse cross section to receive the teeth on a mating worm, spur gear or helical gear. A plurality of modular gear teeth can be mounted on a planar surface or annular rim of a gear blank by commercial fasteners sufficient to assure compliance with user specifications. This technique of gear manufacturing can be applied to helical, spur and bevel gears, and also applies to worm gear drives to enable change in the mesh point between the worm and the gear wheel by mounting the modular teeth on the face of a gear blank so that the teeth oscillate about axes normal to the gear face. In this manner and technique of gear manufacture, the gear teeth, which require the most precision finish of the various components of a gear, can undergo their quality processing prior to final assembly, while the parts that do not require such precision finish, namely the gear blanks, do not undergo costly finishing.

Further objects and advantages of the present invention will become apparent from the following detailed description of the invention when taken in conjunction with the accompanying drawings wherein like references numerals represent like elements throughout the several views.

### BRIEF DESCRIPTION OF THE DRAWINGS

FIG. 1 is a perspective view of a modular gear tooth, termed a modular female gear tooth, constructed in accordance with one embodiment of the present invention;

FIG. 2 is a perspective view of a cap screw type fastener for securing the modular gear tooth of FIG. 1 to a mounting surface on a gear blank;

FIG. 3 is an elevational side view of the modular female gear tooth of FIG. 1 shown mounted on the support cap screw of FIG. 2 and with portions broken away for clarity;

FIG. 4 is an elevational end view of the gear tooth of FIG. 3, taken substantially along line 4-4 of FIG. 3;

FIG. 5 is an elevational view of the opposite end of the gear tooth of FIG. 3 taken substantial along line 5-5 of FIG. 3;

FIG. 6 is a perspective view of a spur gear having modular gear teeth in accordance with the present invention mounted on a planar annular surface of a gear blank such that the gear teeth can pivot or oscillate about axes lying on a common diameter concentric with the rotational axis of gear, one gear tooth being removed for illustrative purposes;

FIG. 7 is a schematic elevational view illustrating the spur gear of FIG. 6 mounted in driven relation with a worm;

FIG. 8 is a plan view illustrating the drive relation between a worm with the spur gear of FIG. 5 having modular gear teeth supported on a planar annular surface of the gear blank in accordance with one embodiment of the present invention;

FIG. 9 is a fragmentary perspective view schematically illustrating a pair of adjacent modular male gear teeth in combination with a worm in accordance with an alternative embodiment;

FIG. 10 is a fragmentary perspective view illustrating an alternative embodiment of a modular gear tooth for mounting on an annular peripheral rim surface of a gear blank in a worm driven gear assembly; and.

FIG. 11 is a schematic planar sectional view taken substantially along the longitudinal axis of a gear drive assembly that employs a single worm to effect rotation of a pair of laterally spaced axially aligned spur gears having modular female gear teeth in accordance with the present invention mounted on annular planar support surfaces on the gear blanks.

### DETAILED DESCRIPTION OF THE INVENTION

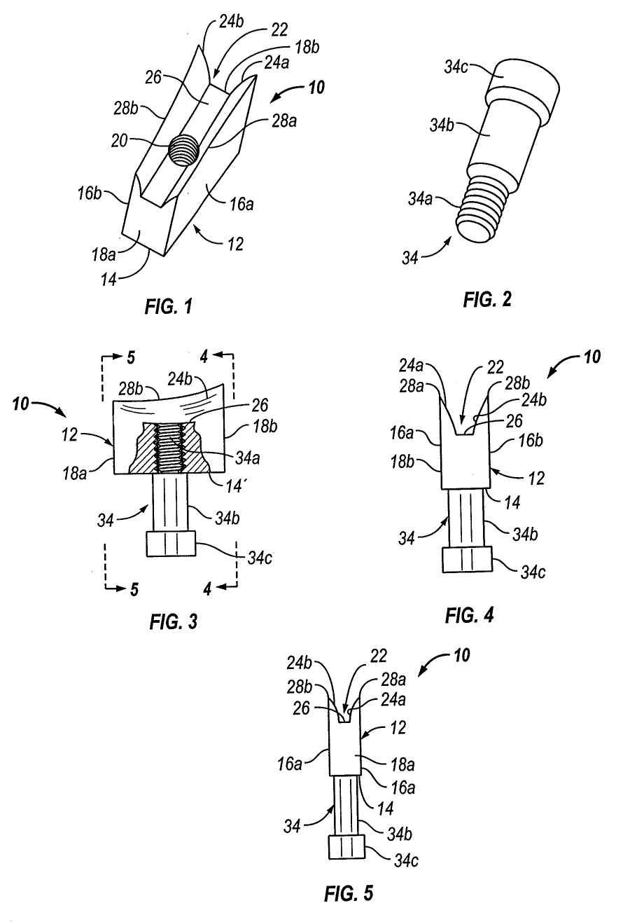

Referring now to the drawings, and in particular to FIGS. 1-5, a modular gear tooth constructed in accordance with one embodiment of the present invention is indicated generally at 10 in FIG. 1. As will be described, the modular gear tooth 10, which may be termed a female modular gear tooth, is adapted for mounting on a gear blank or wheel having an annular planar gear tooth mounting surface thereon so that a plurality of similarly mounted modular gear teeth cooperate to define a gear adapted for driven cooperation with a worm to rotate the associated gear. The modular gear teeth 10 are preferably made of a material suitable for their intended application or usage such as a suitable metal, composite material or other material that exhibits the desired strength and wear characteristics desired for the particular intended application.

Each modular gear tooth 10 includes a generally rectangular tooth body 12 having a planar base surface 14 adapted for interfacing with a planar gear tooth mounting surface on a gear blank as will be described. The tooth body 12 has a pair of external planar side surfaces 16a and 16b that lie in planes normal to the base surface 14, and intersect a pair of longitudinally spaced planar end surfaces 18a and 18b that are also normal to the base surface 14. The end surfaces 18a,b lie in parallel planes transverse to the longitudinal axis of the modular gear tooth 10, form generally right angle corners with the base surface 14 and intersect the side surfaces 16a,b to establish corner edges normal to the base surface. When intended for use to create a worm gear drive assembly, a plurality of the gear teeth 10 are mounted on a planar annular surface of a gear blank face so that each gear tooth has a pivot or oscillatory axis that is normal to both the base surface 14 and the planar mounting surface on the gear blank and lies on a common diameter concentric to the rotational axis of the gear blank. The planes of the tooth body side surfaces 16a,b are formed so as to taper toward each other from one end surface, such as 18b, to the other end surface, such as 18a, at predetermined equal angles of taper and symmetrical relative to the longitudinal axis of the modular gear tooth.

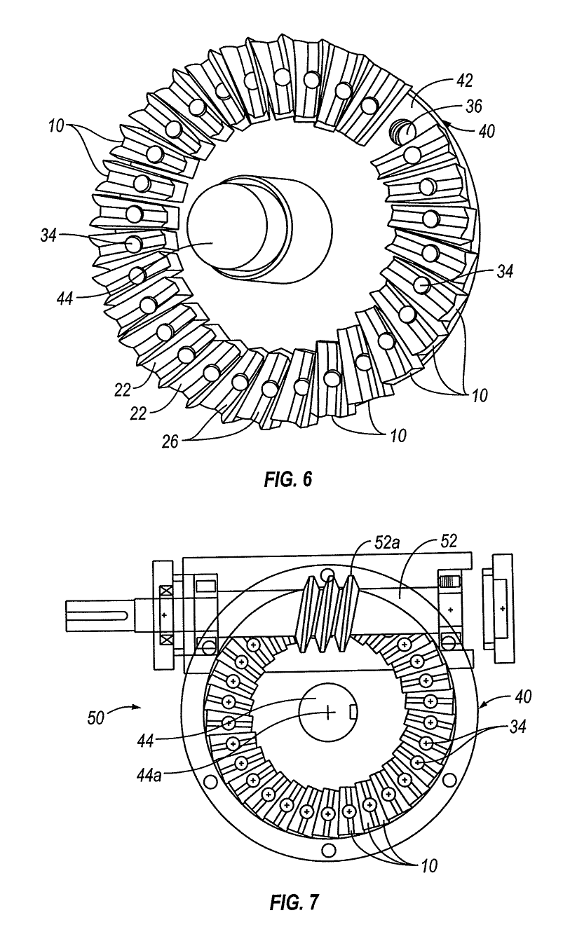

To facilitate such pivotal or oscillatory movement of the gear teeth 10, each of the gear teeth 10 has a threaded bore, such as indicated at 20 in FIGS. 1 and 3, formed at the geometrical center of its base surface 14 and normal thereto. The threaded bores 20 are sized to receive the threaded end 34a of a stepped shank 34b of a cap screw 34. As will be described, in the embodiment illustrated in FIGS. 6-8, the shanks of the cap screws 34 are slidingly received within cylindrical bores, one of which is indicated at 36 in FIG. 6, formed in the gear blank so that the bores 36 are normal to a planar annular mounting surface 42 and their axes lie on a common diameter concentric with the rotational axis of the gear blank. The angle of taper of the gear teeth side surfaces 16a,b is determined by the extent of angular pivoting or oscillation that the modular gear teeth will undergo about the axes of their support screws 34 when mounted on the planar mounting surface 42 during intermeshing with a worm. The extent of such pivotal or angular oscillation of the gear teeth is in turn a function of the linear pitch of the worm when in driving relation with the modular gear teeth.

As illustrated in FIGS. 1, 4 and 5, each modular gear tooth body 12 has a longitudinally extending recess or cavity 22 formed therein generally centrally between the converging external sidewall surfaces 16a,b. Each recess 22 extends the full longitudinal length of the modular gear tooth so as to intersect the transverse end surfaces 18a,b. The longitudinal recess 22 is of generally uniform transverse cross section throughout its length and is defined between laterally opposed inner surfaces 24a and 24b that may be termed lateral boundary surfaces for recess 22 and extend upwardly and diverge arcuately outwardly from a bottom base surface 26 of the recess. The base surface 26 is of equal transverse width throughout its length and is arcuate or concave when considered in side profile as in FIG. 3. The bottom base surface 26 has a radius of curvature slightly greater than the outer diameter of a worm that will be supported in driving relation with the gear teeth when mounted on the planar mounting surface 42 of a gear blank 40. In the modular gear tooth embodiment illustrated in FIGS. 1 and 3-5, the upwardly diverging inner surfaces 24a,b intersect the converging external planar sidewall surfaces 16a and 16b, respectively, to establish substantially equal arcuate concave upper marginal edges 28a and 28b. The marginal edges 28a,b form the lateral boundaries of the upper open entrance to the recess 22 and have substantially equal generally concave curvature, as viewed in side elevation in FIG. 3, slightly greater than the radius of the base diameter or bottom land of the worm thread with which the gear teeth cooperate in a worm gear drive system. The profiles of the upwardly diverging boundary surfaces 24a,b on the modular teeth and the depth and radius of curvature of the recess base surface 26 relative to the marginal edges 28a,b are established so that the modular gear teeth will receive a worm thread of predetermined profile, pitch and lead in sliding driving relation and minimize the friction and wear on both the worm and gear teeth in a worm gear drive. It will be appreciated that because the outer side wall surfaces 16a,b of the modular gear teeth 10 converge from the end surface 18b to end surface 18a, the depth of the recess 22 will be greater adjacent end surface 18b than adjacent end surface 18a.

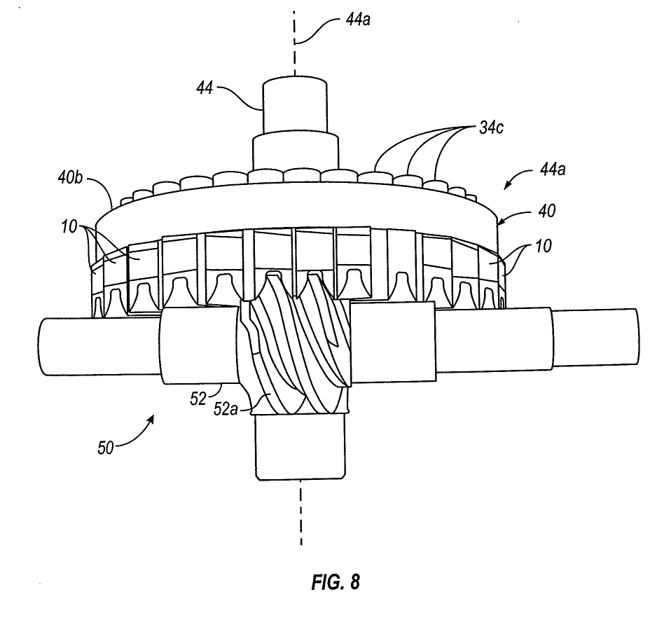

Referring to FIGS. 7 and 8, a worm gear drive system is indicated generally at 50 and includes a plurality of modular gear teeth 10 mounted on the annular planar support surface 42 of a circular gear blank 40 for cooperating relation with a worm 52. The gear blank 40 has an axial bore sized to snugly receive a support shaft 44 on which the gear blank is affixed by a suitable keyway and key. The gear tooth support surface 42 lies in a plane transverse or normal to the axis of rotation of the gear blank as indicated by centerline 44a of support shaft 44. The modular gear teeth 10 are mounted on the planar annular support surface 42 so that the longitudinal axes of their support screws 34 lie on a common diameter concentric with the rotational axis 44a of the gear blank in a manner to allow pivotal or oscillating movement of the gear teeth about the axes of their support screws 34 as they receive a worm thread in driving relation. In the illustrated embodiment, the enlarged cap ends 34c on the cap screws 34 are adapted to abut the outer planar surface 40b on the gear blank, or abut the base surfaces of suitable bores in the gear blank sized to receive the screw end caps, and establish a predetermined length of the shank 34b so that when the threaded end 34a is fixed within the threaded bore 20 in a modular gear tooth, the gear tooth base surface 14 is free to slidingly rotate or oscillate on the planar gear blank mounting surface 42 about the longitudinal axis of the cap screw.

As described, the bottom arcuate surfaces 26 of the modular gear teeth 10 are formed with a radius of curvature generally equal to the radius of the thread on the worm drive gear but deep enough to provide clearance for the outer land on the worm thread. The number of modular gear teeth 10 that are mounted on the spur gear blank 40 is determined by the size of the spur gear, and particularly the diameter of the annular mounting surface 42 and the relative size of the modular gear teeth to obtain a desired speed ratio between the driven spur gear and a worm mounted for driving relation with the spur gear. For example, if a speed ratio of 30 to 1 (30:1) is desired between a worm, as indicated at 52 in FIG. 7, and the spur gear blank 40 having modular gear teeth 10 mounted thereon, the spur gear blank would be sized to enable 30 modular gear teeth to be mounted thereon in circumferential relation so that the spur gear would undergo one revolution for each 30 rotational revolutions of the worm 52a, it being understood that the lead angle of the thread on the worm gear must be selected to create the desired speed ratio.

As aforedescribed, the modular gear teeth 10 are configured such that the external side surfaces 16a and 16b taper inwardly relative to each other and symmetrical to the longitudinal axis of the tooth body from the outer end surface 18b toward the opposite inner end surface 18a and considered in FIG. 1. The taper is established so that when the modular gear teeth are mounted on a planar annular surface of a spur gear blank, such as 42, the modular gear teeth can pivot or oscillate about the axes of the corresponding mounting cap screws 34 to accommodate rotational movement of the worm as each successive modular tooth receives the thread on the worm to rotationally advance the spur gear about its rotational axis 44a without successive modular teeth interfering with each other.

FIG. 7 schematically illustrates the spur gear 40 having individual modular gear teeth 10 mounted about a common diameter on the annular gear tooth mounting surface 42 with the worm 52 being supported in juxtaposition to the gear teeth so that the worm thread 52a is in driving relation with the modular gear teeth.

FIG. 8 is a plan view illustrating the drive relation of the worm 52 in intermeshing relation with two adjacent modular gear teeth 10 on the gear wheel 40 such that rotation of the worm about its longitudinal axis causes rotation of the gear wheel about its rotational axis.

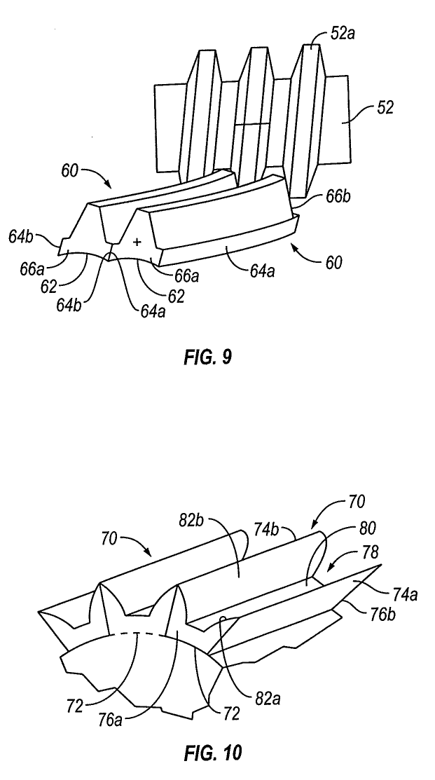

FIG. 9 is a perspective view illustrating a pair of adjacent modular gear teeth, each of which is indicated generally at 60, in accordance with an alternative embodiment of modular gear teeth operative form a worm gear or worm wheel in accordance with the present invention. The modular gear teeth 60 may be termed “male” gear teeth and each has a length and a transverse profile similar to a helical gear tooth that would be conventionally cut on the annular circumferential rim surface of a conventional helical gear blank having the gear teeth formed integral with the gear blank. Each of the modular gear teeth 60 has a base surface 62 formed with a concave radial curvature that extends the full length of the gear tooth and has a radius of curvature substantially equal to the radius of the gear blank rim surface to enable mounting of the gear tooth on the annular peripheral rim surface of a gear blank by suitable fastener means. The centerline of the concave curvature of the base surface 62 is angled or offset from parallel with the longitudinal axis of the modular gear tooth 60 at a predetermined angle so that the gear teeth 60 can be mounted on an annular cylindrical circumferential rim of a worm wheel blank to establish a predetermined helix angle between the longitudinal axis of the modular gear tooth and a radial plane containing the rotational axis of the worm wheel blank. The gear teeth 60 have parallel planar external side edge surfaces 64a and 64b that extend the full length of the modular gear teeth 60 between opposite end surfaces 66a and 66b and are formed to interface with external side edge surfaces of similar adjacent gear teeth when mounted in abutting relation on the rim surface of a spur gear or worm wheel blank. The upper portion of each of the modular teeth 60 has a transverse profile similar to the transverse profile of a gear tooth as formed on a helical gear blank by conventional cutting or hobbing to enable cooperation with the thread 52a on a worm 52 as illustrated in FIG. 9. The modular gear teeth 60 can be mounted on the gear blank by conventional mounting means, such as the cap screws 34, so that the longitudinal side edge surfaces 64a,b abut adjacent side edges to create recesses between adjacent gear teeth to receive the worm thread. In this manner, adjacent abutting modular gear teeth 60 mounted about the cylindrical periphery of the rim of a gear or worm wheel blank establish helix angle recesses between adjacent gear teeth to receive the helical thread on a worm and enable driving rotation of the thus formed worm wheel or gear.

FIG. 10 is a perspective view illustrating another embodiment of modular gear teeth, indicated generally at 70, in accordance with the present invention. Each modular gear tooth 70 is similar to the modular gear tooth 10 but is configured for mounting on the annular peripheral rim surface of a spur gear or worm wheel blank rather than on a planar annular gear mounting surface such as indicated at 42 in FIG. 6. To this end, the modular gear tooth 70 includes a tooth body having a concave base surface 72, planar diverging side surfaces 74a,b, and parallel planar end surface 76a,b that form generally right angle corners with the side surfaces to form a generally rectangular tooth body. In similar fashion to the modular gear teeth 10, the gear tooth 70 includes a recess 78 that extends the full longitudinal length of the tooth body and is defined by an internal bottom surface 80 and laterally spaced inner wall surfaces 82a and 82b. The inner wall surfaces 82,a diverge upwardly and outwardly to accommodate the thread on a worm gear and intersect the external side surfaces 74a,b to create upper marginal edges that establish the recess opening opposite the bottom surface.

The concave base surface 72 of each modular gear tooth 70 has a radius of curvature substantially equal to the radius of curvature of the cylindrical annular peripheral rim surface on a gear blank to enable full contact between the base surfaces and the rim surface. The modular teeth 70 includes means, such as a threaded bore formed in the tooth body preferably at the geometrical center of the base surface, to facilitate mounting on the gear or worm wheel rim surface by suitable fastener means, such as a cap screw 34. In this manner, a plurality of modular gear teeth 70 can be mounted on the annular rim of a gear blank so as to extend fully around the rim for cooperation with the thread of a worm to drive or rotate the resulting worm wheel or worm gear. The external planar side surfaces 74a,b of the modular gear teeth 70 are preferably inclined outwardly from their intersection with the concave base surface to the outer marginal edges so as to lie in radial planes that intersect the rotational axis of the gear or worm wheel blank and thereby effect full side surface contact with adjacent modular gear teeth. It will be appreciated that the bottom surfaces 80 of the recesses 78 are sufficiently concave to accommodate the worm thread during rotation of the worm.

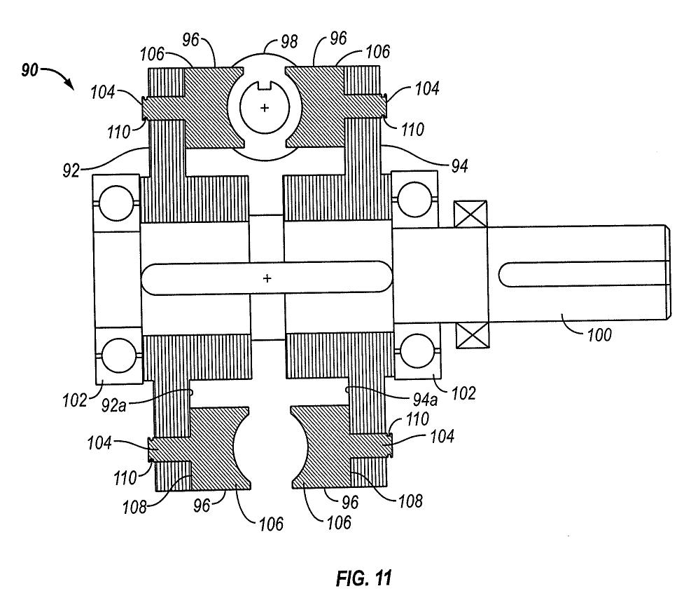

FIG. 11 illustrates a worm gear drive assembly, indicated generally at 90, that employs a pair of substantially identical laterally opposed and axially aligned circular wheel blanks 92 and 94 each of which has a plurality of individual modular gear teeth 96 mounted thereon for driven relation with a common worm shaft 98 similar to the worm shaft 52. The wheel blanks 92, 94 are keyed to a cylindrical driven shaft 100 that in turn is supported by a housing (not shown) for rotation abut the longitudinal axis of shaft 100 through suitable bearing 102. The modular gear teeth 96 are modular gear teeth 10 and are mounted on planar similar mounting surfaces 92a and 94a on their respective wheel blanks 92, 94 through cylindrical stub shafts 104. The stub shafts are formed integral with the gear tooth bodies 106 so as to extend perpendicular to the corresponding planar external rectangular base surface 108 at the geometrical center of the base surfaces 108. The cylindrical stub shafts 104 are slidingly received within suitable cylindrical bores in the wheel blanks 92 and 94 to enable oscillation of the modular gear teeth about the longitudinal axes of the stub shafts with the gear tooth base surfaces 108 in sliding contact with the mounting surfaces 92a,b. The stub shafts 104 have annular ring retainer grooves 110 formed at their free ends to receive conventional retainer rings for retaining the modular gear teeth mounted on the wheel blanks.

The modular gear teeth 96 are mounted on their corresponding wheel blanks 92 and 94 so that their stub shaft pivot axes lie on equal diameter circles concentric with the rotation axis of shaft 100. The planar outer side surfaces of the gear teeth 96 are tapered from their radial outer ends toward their inner ends in similar fashion to the modular gear teeth 10 and are spaced apart sufficiently to enable oscillating movement of the gear teeth when engaged by the thread on the worm 98. It will thus be appreciated that rotation of the single worm 98 will cause rotation of the laterally opposed wheel blank 92, 94 in the same rotational direction and thereby effect rotation of the driven shaft 100 with a higher rotational torque than were only one of the wheel blanks to be driven by the worm.

While preferred embodiments of modular gear teeth and worm driven gears and worm wheels assemblies have been illustrated and described, it will be understood by those skilled in the art that changes and modifications may be made herein without departing from the invention in its broader aspects. Various features of the present invention are defined in the following claims.

1. A modular gear tooth for use on a gear blank having a gear tooth mounting surface thereon, said modular gear tooth comprising a generally rectangular tooth body having a base surface adapted for interfacing with the gear tooth mounting surface on the gear blank, a pair of external side surfaces disposed normal to said base surface, a pair of longitudinally spaced end surfaces disposed substantially normal to said base surface, and a longitudinally extending recess defined between said side surfaces and intersecting said end surfaces, said recess opening outwardly of the tooth body in a direction opposite said base surface and having a profile transverse to a longitudinal axis of the tooth body configured to receive a gear tooth on a drive gear in sliding relation, said tooth body being adapted for mounting on the gear tooth mounting surface in a manner to enable oscillating movement of the tooth body about an axis generally normal to the base surface.

2. A modular gear tooth as defined in claim 1 wherein said longitudinal recess is defined between laterally opposed side surfaces that extend upwardly from a bottom surface of the recess to said open end of said recess, said side surfaces diverging progressively outwardly toward said recess opening so as to define convex arcuate side surfaces when the recess is considered in transverse profile.

3. A modular gear tooth as defined in claimed 2 wherein each of said laterally opposed internal side surfaces intersects a corresponding external side surface to create a concave marginal edge, as considered in side profile.

4. A modular gear tooth as defined in claim 2 wherein said bottom surface of the recess is defined by a concave surface extending the full length of said recess as considered in a plane normal to said base surface and containing the longitudinal axis of the tooth body.

5. A modular gear tooth as defined in claim 4 wherein said bottom concave surface lies in an arcuate plane disposed substantially perpendicular to said external side surfaces.

6. A modular gear tooth as defined in claim 4 wherein said recess bottom concave surface has a radius of curvature similar to the radius of curvature of a thread on a worm gear when the modular gear tooth is supported in cooperative relation with the worm gear.

7. A modular gear tooth as defined in claim 1 wherein said tooth body has a bore formed therethrough adapted for cooperation with a fastener to mount the modular tooth on the gear tooth mounting surface.

8. A modular gear tooth as defined in claim 7 wherein said bore has an internal thread for cooperative relation with a threaded screw fastener operative to mount the modular gear tooth on the gear blank mounting surface in a manner to allow oscillation of the tooth about the axis of the bore.

9. A modular gear tooth as defined in claim 7 wherein said bore is formed normal to and mid-length of said base surface and intermediate a transverse width of the tooth body at said mid-length thereof.

10. A modular gear tooth as defined in claim 1 wherein said external side surfaces diverge outwardly from a first one of said end surfaces to the other of said end surfaces, as considered in a plane parallel to said base surface.

11. A worm drive system comprising:
a worm wheel mounted for rotation about a worm wheel axis of rotation and defining a planar mounting surface thereon disposed transverse to said worm wheel axis of rotation;
a plurality of substantially identical modular gear teeth supported on said mounting surface for oscillational movement about axes normal to said mounting surface and lying on a common diameter concentric with said axis of rotation, each of said modular gear teeth having an external base surface and laterally spaced external planar side surfaces disposed normal to said base surface and lying in planes converging from a first end surface normal to said external base surface to a second end surface normal to said external base surface, each of said gear teeth including a recess formed along a longitudinal length thereof and having an arcuate bottom surface of substantially uniform transverse width along its length, said recess being defined between laterally spaced outwardly diverging wall surfaces that intersect said exterior side surfaces to establish an open end of said recess opposite said arcuate bottom surface and bounded by arcuate marginal edges,
and a worm having a rectilinear longitudinal axis and mounted for rotation about said longitudinal axis in a plane transverse to and spaced from said worm wheel axis of rotation, said worm having a worm thread thereon sized to be received in the recesses of successive modular gear teeth so as to effect driving rotation of said worm wheel in response to rotation of said worm.

12. A worm drive system as defined in claim 11 wherein each modular gear tooth has a bore formed therein normal to said external base surface and substantially mid-length thereof, said bore being cooperative with mounting means to enable mounting of the modular gear tooth on the planar mounting surface.

13. A worm gear drive system as defined in claim 11 wherein said bottom surface of each gear tooth recess is defined by a concave surface extending the full length of the recess as considered in a plane normal to the external base surface and containing the longitudinal axis of the gear tooth.

14. A worm gear drive system as defined in claim 13 wherein each of said bottom concave surfaces lies in an arcuate plane disposed substantially perpendicular to said external side surfaces.

15. A worm gear drive system as defined in claim 13 wherein each of said bottom concave surfaces has a radius of curvature similar to the radius of curvature of the worm thread on the worm gear that is received in the recesses of successive modular gear teeth.

16. A worm gear drive system as defined in claim 11 wherein each of said gear teeth has a bore formed therethrough adapted for cooperation with a fastener to mount the modular tooth on the mounting surface.

17. A worm gear drive system as defined in claim 16 wherein each of said bores has an internal thread for cooperative relation with a threaded screw fastener operative to mount the modular gear tooth on the worm wheel mounting surface in a manner to allow oscillation of the tooth about the axis of the bore.

18. A worm gear drive system as defined in claim 16 wherein each of said bores is formed normal to and mid-length of the corresponding base surface and intermediate a transverse width of the gear tooth at the mid-length thereof.

19. A method for making a gear wheel having gear teeth adapted for intermeshing with a drive gear or worm, said method comprising:
providing a circular gear wheel having an axis of rotation and an annular planar mounting surface disposed transverse to said axis of rotation, and
mounting a plurality of individual modular gear teeth on said annular mounting surface for oscillating movement relative to the mounting surface, each of said modular gear teeth including a generally rectangular tooth body having a base surface adapted for interfacing with said mounting surface, external planar side surfaces disposed substantially normal to said base surface and intersecting opposite end surfaces, and a recess extending the longitudinal length of the tooth body between the side surfaces and opening upwardly opposite the base surface, said recess having a transverse profile configured to receive a pinion gear tooth or worm drive thread in sliding relation so as to effect rotation of the gear wheel in response to driving movement of the pinion gear tooth or worm thread.
